(19) United States
(12) Patent Application Publication
(10) Pub. No.: US 2017/0113543 A1
(43) Pub. Date: Apr. 27, 2017

(54) DEF Tank Constraint Using Flexible Medium

(71) Applicant: Caterpillar Paving Products Inc., Brooklyn Park, MN (US)

(72) Inventors: Daniel Joseph Pelarski, Brooklyn Park, MN (US); Robert Kenneth Iverson, Maple Grove, MN (US)

(73) Assignee: CATERPILLAR PAVING PRODUCTS INC., Brooklyn Park, MN (US)

(21) Appl. No.: 14/921,080

(22) Filed: Oct. 23, 2015

(51) Int. Cl. B60K 15/073; B62D 65/02; E01C 19/28; B60K 15/03; F01N 3/20

(52) U.S. Cl. CPC B60K 15/073; B60K 15/03006; F01N 3/206; E01C 19/282; B62D 65/02; B60K 2015/03157; B60K 2015/03171; B60K 15/03177; B60K 2015/03309; B60K 2015/03486; B60K 2015/0638

(57) ABSTRACT

A method of mounting a DEF tank in a recess of a frame of a machine, and such a machine is disclosed. The machine may further comprise a first bracket mounted to the frame, the DEF tank, the fuel tank and a plurality of flexible mediums. The DEF tank is disposed in the recess and may be disposed on top of the first bracket. In an embodiment, the DEF tank is expandable. The fuel tank may be disposed inside the recess. A first portion of the plurality of flexible mediums may be sandwiched between the DEF tank and the frame, and a second portion of the plurality of flexible mediums may be sandwiched between the DEF tank and the fuel tank. Each of the plurality of flexible mediums is configured to constrain the DEF tank from movement that is in excess of expansion of the DEF tank.

### TECHNICAL FIELD

The present disclosure generally relates to constraints for use on Diesel Exhaust Fluid (DEF) tanks, and more specifically to constraints for use on DEF tanks on industrial machines such as compactors and the like.

### BACKGROUND

A DEF tank may be installed on industrial machines used in compacting, earth moving, paving, mining and the like. For example, a DEF tank may be used on a soil compactor. In some environments, the DEF inside the DEF tank may freeze and expand. As such, DEF tanks may be flexible to allow for expansion of the tank walls without incurring damage to the tank. The DEF tank must be properly constrained on the machine to prevent movement of the tank during machine operation that may result in punctures, cracks and/or abrasion damage from surrounding components exterior to the DEF tank.

Japanese publication JP2013092109 discloses a liquid tank and mounting structure. As shown in FIG. 3 of JP2013092109, the tank is constrained by belts 6. Such belts wrap around the tank surface. Use of such restraints with tanks such as a DEF tank, in which the fluid contained inside may freeze and expand, requires close control over the shape of such belts and their tolerance in relation to the contour of the tank surface on which they are positioned. In some embodiments, the belts may only be positioned on tank surfaces that have little or no displacement during expansion of the DEF tank. In other scenarios, the DEF tank may need to have channels or other features molded into the tank to position the straps or prevent the belts from becoming dislodged due to expansion of the tank or vibrational forces from the machine on which the tank is mounted. A better system is needed to constrain a DEF tank on a machine.

### SUMMARY OF THE DISCLOSURE

In accordance with one aspect of the disclosure, a machine is disclosed. The machine may comprise a frame defining a recess configured to contain a DEF tank and a fuel tank, a first bracket mounted to the frame, the DEF tank, the fuel tank and a plurality of flexible mediums. The DEF tank is disposed in the recess and may be disposed on top of the first bracket. In an embodiment, the DEF tank is expandable. The fuel tank may be disposed inside the recess. A first portion of the plurality of flexible mediums may be sandwiched between the DEF tank and the frame, and a second portion of the plurality of flexible mediums may be sandwiched between the DEF tank and the fuel tank. Each of the plurality of flexible mediums is configured to constrain the DEF tank from movement that is in excess of expansion of the DEF tank.

In accordance with another aspect of the disclosure, a method of mounting a DEF tank in a recess of a frame of a machine is disclosed. The recess may contain a fuel tank. The method may comprise mounting a first bracket to the frame, and positioning the DEF tank and a plurality of flexible mediums in the recess adjacent to the fuel tank and the frame. The plurality of flexible mediums are configured to constrain the DEF tank from movement that is in excess of expansion of the DEF tank. The first bracket may include a floor. The DEF tank may be disposed on top of the floor. A first portion of the plurality of flexible mediums may be disposed between the DEF tank and the frame, and a second portion of the plurality of flexible mediums may be disposed between the DEF tank and the fuel tank.

In accordance with a further aspect of the disclosure a machine is disclosed. The machine may comprise a frame, a first bracket, a DEF tank, an angle bracket, a fuel tank, and a plurality of flexible mediums. The frame may define a recess configured to contain the DEF tank and a fuel tank. The frame may include a frame wall disposed on a side of the machine. The frame wall may intersect a frame endwall disposed at a rear of the machine. The first bracket may be mounted to the frame wall and to the frame endwall. The first bracket may be oriented substantially horizontally. The DEF tank may be disposed in the recess and on top of the first bracket. The DEF tank is expandable and includes a plurality of sidewalls. The angle bracket may be mounted to the frame wall and may be disposed substantially parallel to a portion of a first sidewall of the DEF tank. The first sidewall may be disposed opposite to the frame endwall. The fuel tank is disposed inside the recess. The first part of the fuel tank may be disposed proximal to a second sidewall of the DEF tank. The second sidewall of the DEF tank may be disposed opposite to frame wall. The plurality of flexible mediums may include a first portion of the plurality sandwiched between the DEF tank and the frame, and a second portion of the plurality sandwiched between the DEF tank and the fuel tank, and a third portion of the plurality sandwiched between the angle bracket and the DEF tank. The plurality of flexible mediums are configured to constrain the DEF tank from movement within the recess that is in excess of expansion of the DEF tank. In an embodiment, each of the plurality of flexible mediums may be made of foam.

### BRIEF DESCRIPTION OF THE DRAWINGS

FIG. 1 is perspective view of an embodiment of an exemplary machine in which the teachings of this disclosure may be used;

FIG. 2 is perspective view of an embodiment of a portion of the rear of the exemplary machine of FIG. 1 with the hood removed;

FIG. 3 is a perspective view of a portion of the side of the machine of FIG. 1 with a frame wall of the frame removed;

FIG. 4 is a another perspective view of a portion of the rear of the machine of FIG. 1 with the hood, a DEF pump and other related components removed;

FIG. 5 is a perspective view of a portion of the frame of the exemplary machine of FIG. 1.

FIG. 6 is a perspective view showing an exemplary first bracket mounted to the frame of FIG. 5;

FIG. 7 is a perspective view illustrating an exemplary DEF tank (disposed on the first bracket of FIG. 6) and exemplary flexible mediums;

FIG. 8 is another perspective view of the exemplary DEF tank, first bracket and flexible mediums of FIG. 7;

FIG. 9 is another perspective view of the exemplary DEF tank, first bracket and flexible mediums of FIGS. 7-8;

FIG. 10 is an enlarged view of a portion of FIG. 4 with the hood striker member removed;

FIG. 11 is a perspective view of an exemplary angle bracket mounted to the frame wall of FIG. 5; and

FIG. 12 is an enlarged perspective view of a portion of the frame of FIG. 5, a plurality of flexible mediums, the first bracket and the angle bracket.

### DETAILED DESCRIPTION

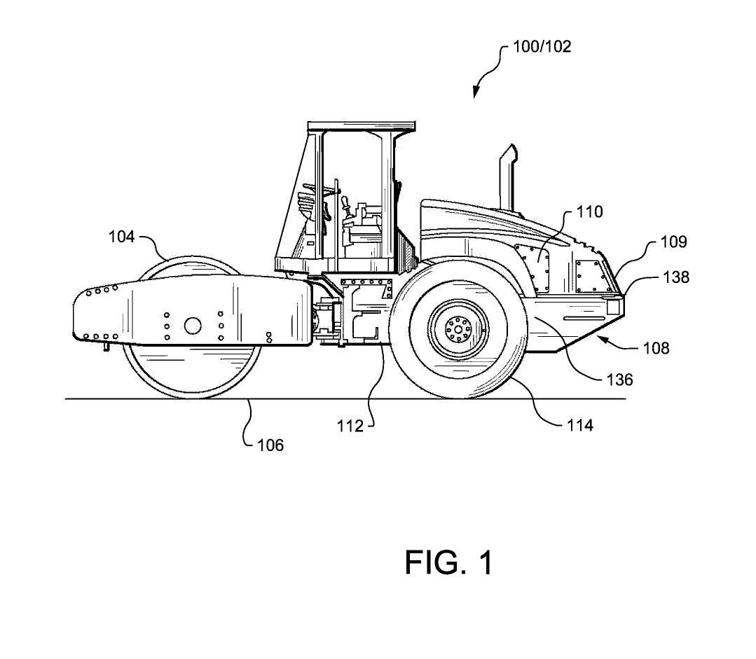

Referring now to FIG. 1, this disclosure describes an exemplary embodiment of a machine 100. While the exemplary embodiment of the machine 100 is described relative to a vibratory compactor 102, the teachings of this disclosure may be employed on other types of machines 100 (for example, earth moving machines, mining machines, agricultural machines, paving machines or other industrial machines). For the purposes of this disclosure the term “machine” includes vehicles.

In the exemplary embodiment, the vibratory compactor 102 may be a self-propelled single drum compactor with a single cylindrical roller drum 104 for compacting work material 106 at a work site. The vibratory compactor 102 includes a frame 108 having a hood 109, and a prime mover such as an engine 110. The engine 110 is a part of a drive system 112 that propels the vibratory compactor 102 as desired. The drive system 112 may operate to drive the roller drum 104 and/or one or more deflectable tires 114.

The rotatable roller drum 104 may be rolled over the surface to compress the work material 106 underneath. In addition to utilizing the weight of the roller drum 104 to provide the compressive forces that compact the work material 106, the vibratory compactor 102 may induce a vibratory forces to the surface of the work material 106. The vibratory forces assist in compacting the work material 106 into a dense mass. To generate the vibratory forces one or more weights or masses (not shown) may be disposed inside the roller drum 104 at a position that is off center from the axis line around which the roller drum 104 rotates. As the roller drum 104 rotates, the position of the masses may induce oscillatory or vibrational forces to the roller drum 104 that are imparted to the surface of the work material 106 being compacted.

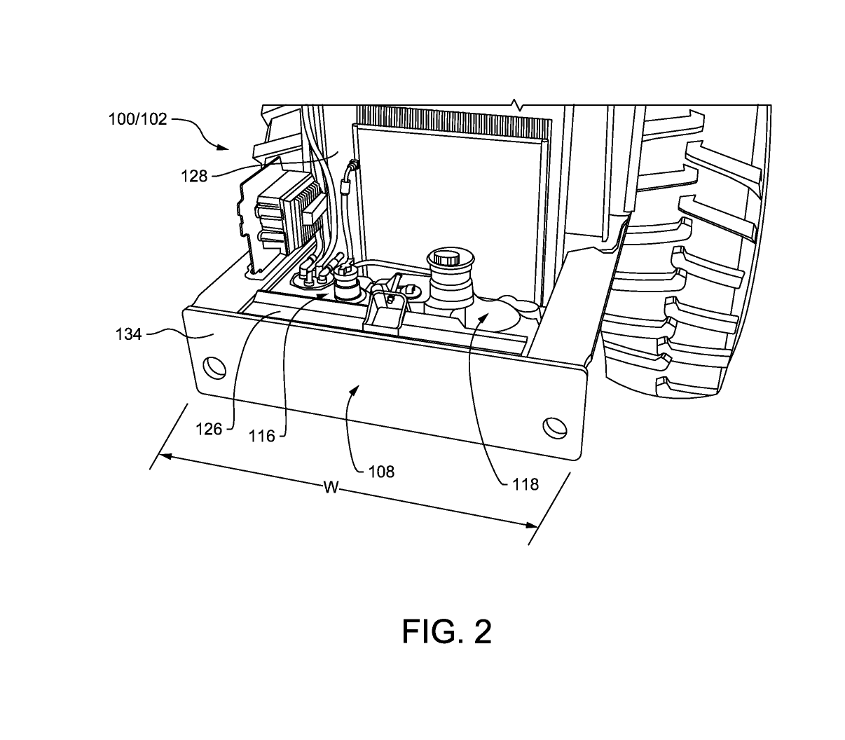

As shown in FIGS. 2-4, the machine 100/102 may further comprise a DEF tank 116, a fuel tank 118, a first bracket 120 and a plurality of flexible mediums 122. In some embodiments, the machine 100/102 may further comprise an angle bracket 124. The machine 100/102 may also further comprise a hood striker member 126. The machine 100/102 may also further comprise a cooling assembly 128.

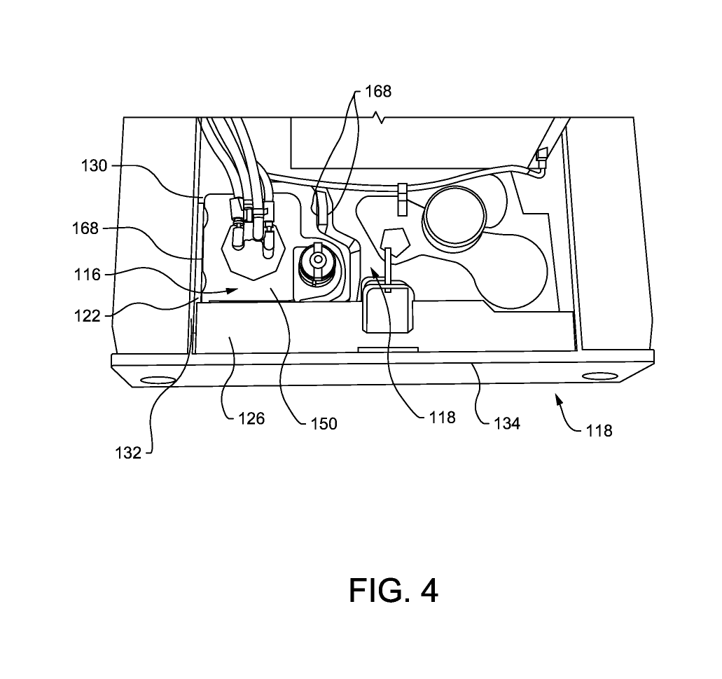

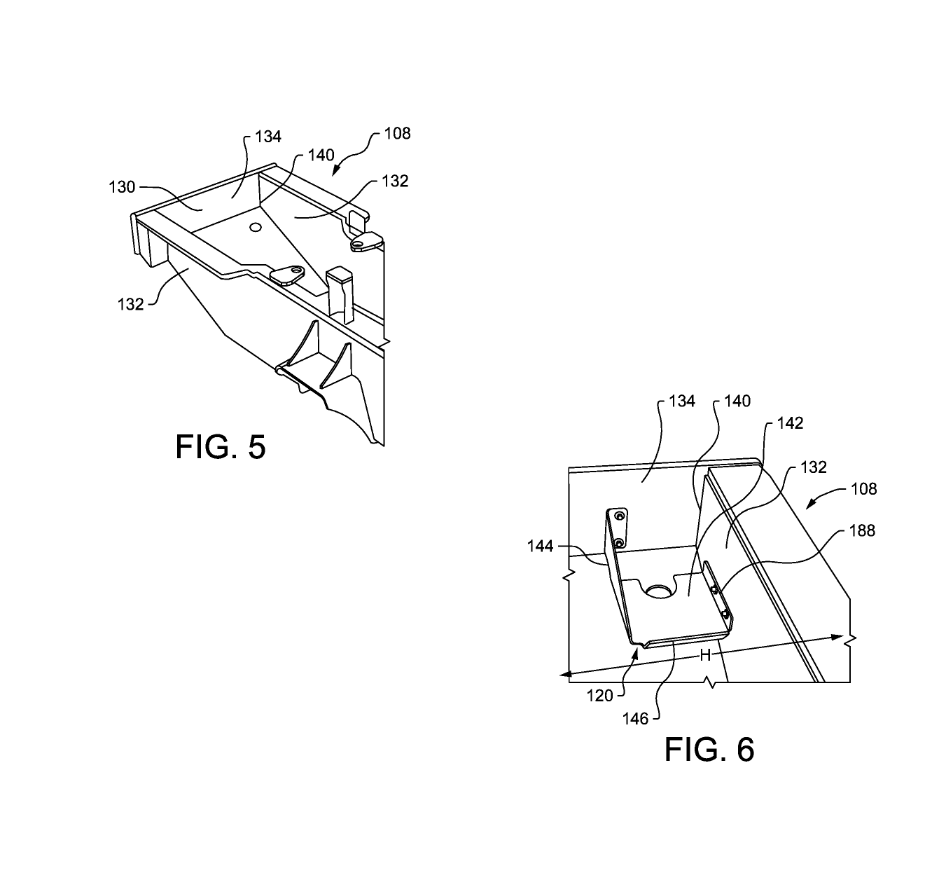

As best seen in FIG. 5, the frame 108 defines a recess 130 configured to contain the DEF tank 116 (FIG. 4) and the fuel tank 118. The frame 108 (FIG. 5) includes a frame wall 132 and a frame endwall 134. The frame wall 132 may be disposed on or along a side 136 (FIG. 1) of the machine 100/102 and the frame endwall 134 may be disposed at the rear 138 of the machine 100/102. The frame endwall 134 (FIG. 2) may be oriented to extend in a direction across the width W of the machine 100/102. In some embodiments, the frame endwall 134 may be a bumper or part of a bumper of the machine 100/102. The frame wall 132 (FIG. 5) may intersect the frame endwall 134. Such intersection may form a corner 140 of the frame 108 and/or recess 130.

As best illustrated in FIG. 6, the first bracket 120 is mounted to the frame 108. The first bracket 120 includes a floor 142. In an embodiment, the first bracket 120 may be oriented substantially parallel to a horizontal plane H. More specifically, in such an embodiment, the floor 142 of the first bracket 120 may be substantially horizontal in orientation (substantially parallel to the horizontal plane H). The floor 142 may be perpendicular to the frame wall 132 and/or to the frame endwall 134. In some embodiments, the first bracket 120 may also include an arm 144 extending upward from the floor 142 to the frame endwall 134. The first bracket 120 may include a mounting piece 188. The first bracket 120 may be mounted to the frame endwall 134 (via the arm 144) and/or mounted to the frame wall 132 via the mounting piece 188.

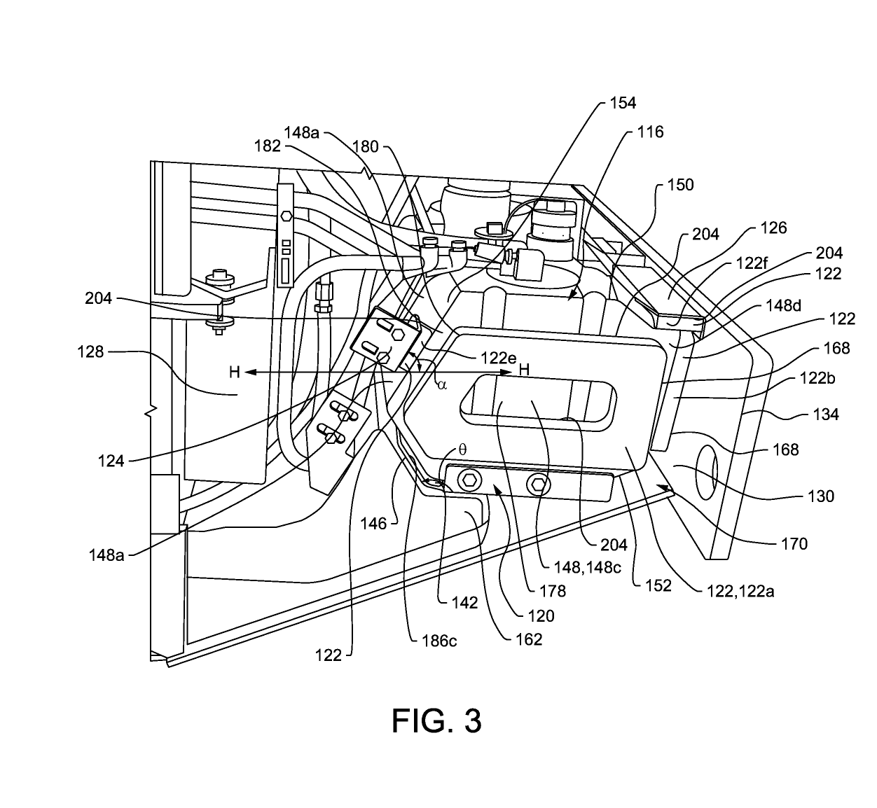

The first bracket 120 may also include a ledge 146 that intersects the floor 142. In some embodiments, the ledge 146 may be angled in a direction away from the floor 142 of the first bracket 120. The angle δ (FIG. 3) between the floor 142 and the ledge 146 may be an obtuse angle. In some embodiments, for example the embodiment shown in FIG. 6, the ledge 146 and the arm 144 do not intersect each other.

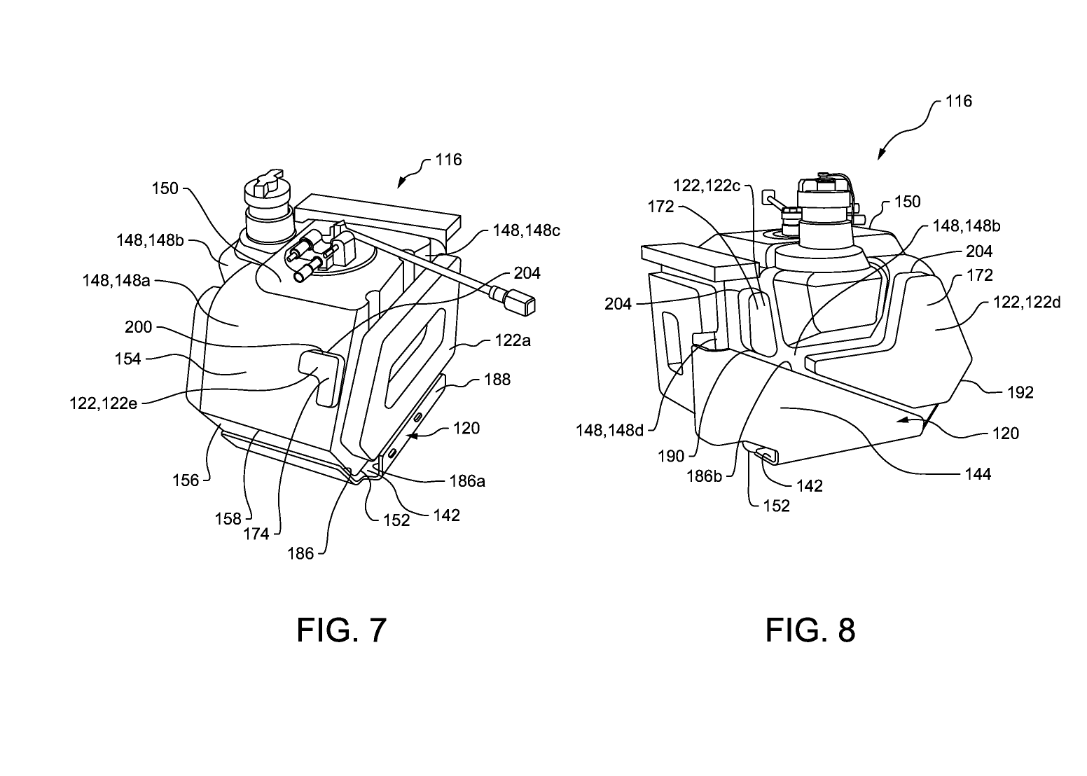

The DEF tank 116 (FIG. 3) is disposed in the recess 130 and on top of the first bracket 120. Turning now to FIGS. 3 and 7-9, the DEF tank 116 includes a plurality of sidewalls 148(a-d), a top wall 150 and a bottom wall 152. In some embodiments, the DEF tank 116 may be in direct contact with the floor 142 (FIGS. 7-8) of the first bracket 120 without any mat, or the like, between the bottom wall 152 of the DEF tank 116 and the floor 142.

A first sidewall 148a of the plurality of sidewalls 148(a-d) may include an upper portion 154 (FIG. 7) and a lower portion 156. The upper and lower portions 154, 156 may be angled or sloped toward each other and may meet at a vertex 158. The vertex 158 may extend across all or part of the first sidewall 148a of the DEF tank 116. In an embodiment the first sidewall 148a may be disposed opposite to the frame endwall 134 (FIG. 3).

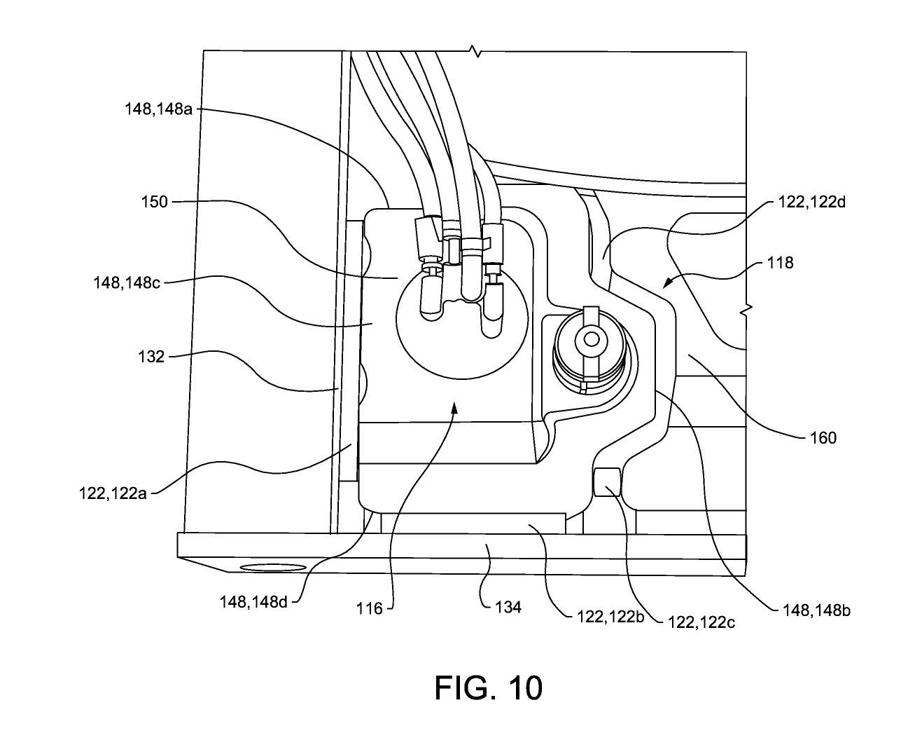

A second sidewall 148b (FIGS. 7-10) of the plurality of sidewalls 148(a-d) may be disposed adjacent to at least a part of the fuel tank 118 (FIG. 10) and opposite to the frame wall 132. A third sidewall 148c of the plurality of sidewalls 148(a-d) may be disposed adjacent to the frame wall 132 and opposite to the second sidewall 148b of the DEF tank 116. The fourth sidewall 148d may be adjacent to the frame endwall 134 and opposite to the first sidewall 148a.

The DEF tank 116 is made of an expandable material to allow the DEF tank 116 to expand when DEF contained inside (the DEF tank 116) freezes. The DEF tank 116, of this disclosure, may be strap free. Strap free meaning that the DEF tank 116 is not in direct or indirect contact with a strap, belt, band clamp (collectively, “strap”) that encircles or wraps around some or all of the DEF tank 116 and is configured or arranged to constrain the DEF tank 116 from movement (in excess of expansion of the tank walls) within the recess 130. For example, in an embodiment the DEF tank 116 may be free of a strap encircling all or part of the DEF tank 116 and anchored to the frame 108 or another stationary component in the recess 130.

The fuel tank 118 is disposed inside the recess 130. A first part 160 of the fuel tank 118 may be disposed proximal to the second sidewall 148b of the DEF tank 116 and may be disposed opposite to the frame wall 132. The contour of the second sidewall 148b of the DEF tank 116 may be in reciprocal relationship to the first part 160 of the fuel tank 118. A second part 162 (FIG. 3) of the fuel tank 118 may be disposed below the DEF tank 116.

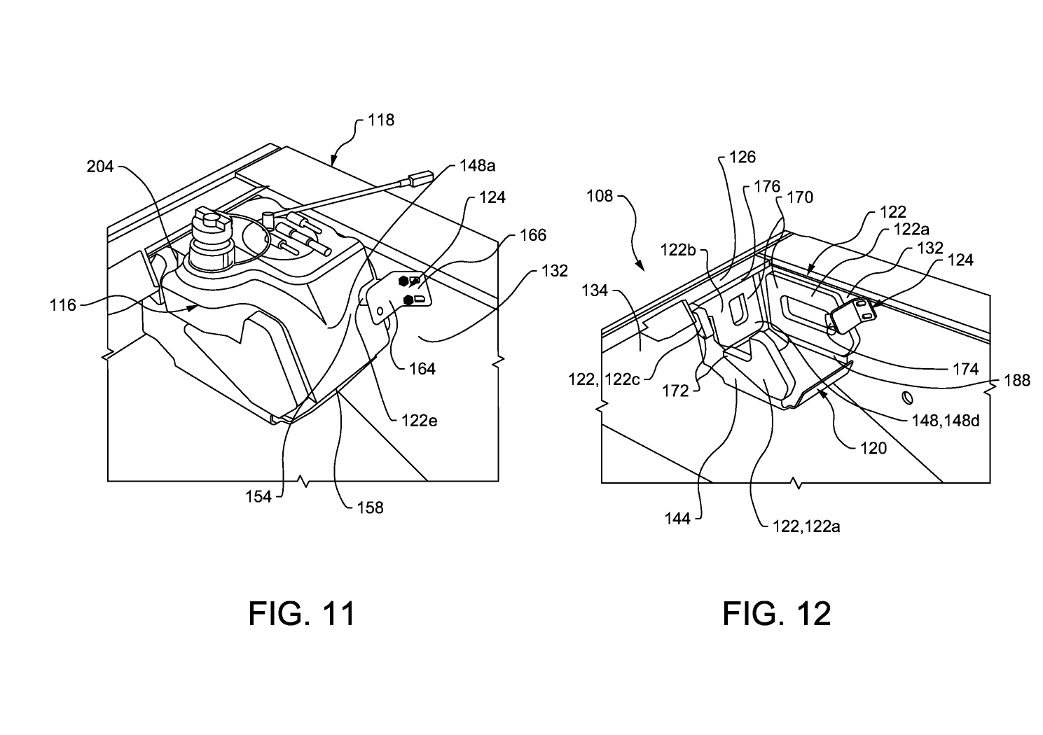

The angle bracket 124 (FIGS. 3 and 11) may be mounted to the frame 108 and disposed adjacent to the DEF tank 116. The angle bracket 124 may include a leg 164 (best seen in FIG. 11) and a mounting member 166. In one embodiment, the angle bracket 124 may be mounted to the frame wall 132 by the mounting member 166 and the leg 164 may be disposed substantially parallel to a portion of the first sidewall 148a of the DEF tank 116. In one embodiment, the leg 164 of the angle bracket 124 may be disposed substantially parallel to the upper portion 154 of the first sidewall 148a of the DEF tank 116 above the vertex 158. In one embodiment, the angle bracket 124 may be mounted to the frame wall 132 at an angle α (FIG. 3) to a horizontal plane H. The angle α is the angle from the horizontal plane H to the surface of the leg 164 that is oriented to face the DEF tank 116. In one embodiment, the angle α may be an acute angle.

The hood striker member 126 (FIG. 4) may be disposed adjacent to frame wall 132 and above the DEF tank 116. The hood striker member 126 may be mounted on the frame endwall 134 of the frame 108 and may extend outward from the frame endwall 134 and over a portion of the top wall 150 of the DEF tank 116. The hood striker member 126 may in one embodiment be a generally L-shaped plate (FIG. 3).

Each of the plurality of flexible mediums 122 is configured to constrain the DEF tank 116 from movement in one or more directions (e.g., movement side-to-side, fore-to-aft, vertically, diagonally and/or the like), which is in excess of expansion of the DEF tank 116, within the recess 130. DEF under certain conditions may freeze. The DEF tank 116 is expandable to accommodate the expansion of the volume of the DEF that may result when the DEF freezes. Such expansion of the DEF volume may exert force(s) on the DEF sidewalls 148, DEF top wall 150 and/or DEF bottom wall 152 to cause one or more of the preceding to expand in an outward direction. Each of the plurality of flexible mediums 122 is configured to constrain the DEF tank 116 from movement in excess of such expansion of the DEF sidewalls 148, DEF top wall 150 or DEF bottom wall 152.

Each of the flexible mediums 122 resists degradation when exposed to DEF, diesel fuel, hydraulic fluid/oil, and the like. The flexible mediums 122 may be made of foam, or the like. In one embodiment, one or more of the flexible mediums 122 may be a panel. In some embodiments, one or more of the flexible mediums 122 may have a substantially even contact surface 168 (see for example, FIGS. 3-4). A contact surface 168, as used herein, is a surface that is in contact (either directly or indirectly via adhesive 204, or the like) with the DEF tank 116, the frame 108, the fuel tank 118, the angle bracket 124 or the hood striker member 126. In other embodiments, one or more contact surfaces 168 of the flexible medium 122 may be uneven and have ridges, ripples, undulations or the like.

In some embodiments, a flexible medium 122 (FIG. 3) may define a hole 178 therethrough. In other words, a flexible medium 122 may surround a hole 178 that extends through the flexible medium 122. In other embodiments, the flexible medium 122 may not have such a hole 178 therethrough.

FIG. 12 illustrates an enlarged perspective view of a portion of the frame 108, a plurality of flexible mediums 122, the first bracket 120 and the angle bracket 124. In FIG. 12, the DEF tank 116 is not shown in the drawing in order to better illustrate one exemplary arrangement of the plurality of flexible mediums 122 in relation to the frame wall 132, frame endwall 134, first bracket 120, the angle bracket 124 hood striker member 126.

A first portion 170 of the plurality of flexible mediums 122 may be disposed or sandwiched between the DEF tank 116 and the frame 108. A second portion 172 of the plurality of flexible mediums 122 may be disposed or sandwiched between the DEF tank 116 and the fuel tank 118 (FIG. 10). A third portion 174 (FIG. 12) of the plurality of flexible mediums 122 may be disposed or sandwiched between the angle bracket 124 and the DEF tank 116 (FIG. 11). A fourth portion 176 (FIG. 12) of the plurality of flexible mediums 122 may be disposed or sandwiched between the DEF top wall 150 and the hood striker member 126. Each portion 170, 172, 174, 176 may include one or more flexible mediums 122.

In the exemplary embodiment shown in FIGS. 3, 10 and 12, the first portion 170 of the flexible mediums 122 may include a first flexible medium 122a disposed between the frame wall 132 (FIG. 10) and the third sidewall 148c of the DEF tank 116 and a second flexible medium 122b disposed between the frame endwall 134 and the fourth side 148d of the DEF tank 116.

In one embodiment, one or more flexible mediums 122 may be held in place on the DEF tank 116, the frame 108, the angle bracket 124, or the hood striker member 126 with the use of an adhesive 204 (FIG. 3), or the like. In other embodiments, one or more flexible mediums 122 may be held in place (between the DEF tank 116 and the frame 108, between the DEF tank 116 and the fuel tank 118, between the DEF tank 116 and the angle bracket 124, or between the DEF tank 116 and the hood striker member 126) without the use of adhesives, bolts, clips, straps, or other mounting mechanisms.

In some embodiments, one or more flexible mediums 122 may be made of a low density foam such as an open cell foam made of polyester, polyether urethane, or the like. Low density foam is one that requires more than about 5 kPa and less than about 15 kPa of contact pressure (by a wall of the DEF tank 116) to compress the foam flexible medium 122 about 25% of its thickness. The density of such low density foam flexible medium 122 may be in the range of 28.8 kg/m³ to about 35.2 kg/m³. In some embodiments, one or more flexible mediums 122 may be made of a higher density foam such as a high density closed cell expanded rubber foam (for example, one made of cellular polychloroprene, or the like) that requires about 15 kPa to about 35 kPA of pressure (by a wall of the DEF tank 116) to compress the foam flexible medium 122 about 25% of its thickness. The density of such higher density foam flexible medium 122 may be in the range of about 140 kg/m³ to about 180 kg/m³.

In one embodiment, the first flexible medium 122a may be a generally flat panel having a general ring shape that defines a hole 178 therethrough. The term ring shape may include a shape with rounded or squared corners that encircles or surrounds the hole 178 therethrough. In the exemplary embodiment, illustrated in FIG. 3 it can be seen that the outer perimeter 180 of the first flexible medium 122a may follow the shape of the perimeter 182 of the third sidewall 148c of the DEF tank 116.

In an embodiment, the first flexible medium 122a may be configured to limit side-to-side motion of the DEF tank 116 and to compress relatively easily toward the frame wall 132 (FIG. 10) when pressed by the third sidewall 148c of the DEF tank 116 when it expands outward. The first flexible medium 122a is also resilient; the first flexible medium 122a will uncompress/expand as the third sidewall 148c contracts (when the DEF inside contracts) and continue to fill the space between the third sidewall 148c of the DEF tank 116 and the frame wall 132. In one embodiment, the first flexible medium 122a may be a low density open cell foam made of polyester, polyether urethane, or the like that requires less than about 15 kPa of pressure to compress the foam 25% of its thickness. The density may be in the range of 28.8 kg/m³ to about 35.2 kg/m³.

The disposition of the first flexible medium 122a between the frame wall 132 and the third sidewall 148c of the DEF tank 116 may maintain a gap 186a (best seen in FIG. 7) between the DEF tank 116 and the mounting piece 188 of the first bracket 120. The gap 186a may be an air gap.

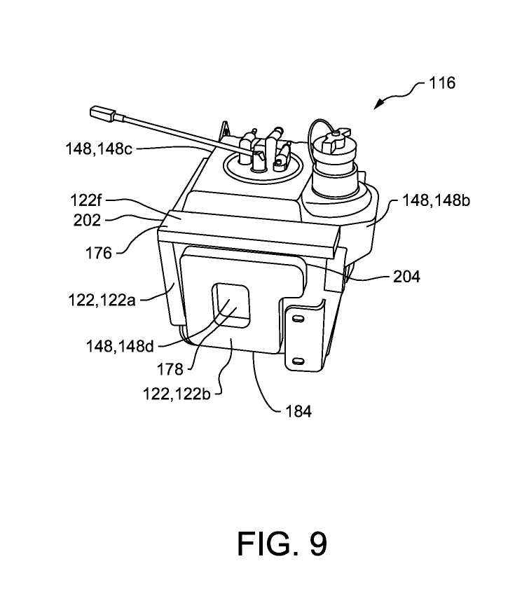

In one embodiment, the second flexible medium 122b (FIGS. 9 and 12) be a generally flat panel having a general ring shape that defines a hole 178 therethrough. In an embodiment, the second flexible medium 122b may be a foam that has a higher density than that of the first flexible medium 122a. For example, the second flexible medium 122b may be a high density foam that requires about 15 to about 35 kPA of pressure to compress the foam 25% of its thickness. The density may be in the range of about 140 kg/m³ to about 180 kg/m³. In such an embodiment, the second flexible medium 122b may be configured to compress from expansion of the fourth sidewall 148d but not to the extent that bolts or the like that may be protruding from or disposed near the frame endwall 134 could rupture the DEF tank 116 either by coming directly into contact with the DEF tank 116 (near the perimeters of the second flexible medium 122b) or indirectly into contact through the second flexible medium 122b.

The second flexible medium 122b may be a different size and/or shape than that of the first flexible medium 122a. For example, the second flexible medium 122b may have a smaller outer perimeter 184 (FIG. 9) than the outer perimeter 180 (FIG. 3) of the first flexible medium 122a.

The second portion 172 (FIG. 8) of the plurality of flexible mediums 122 may include a third flexible medium 122c (FIGS. 8 and 12) and a fourth flexible medium 122d. As shown in FIG. 10, the third and fourth flexible mediums 122c, 122d may each be disposed or sandwiched between the DEF tank 116 and the fuel tank 118. The disposition of the third and fourth flexible mediums 122c, 122d between the fuel tank 118 and the second sidewall 148b of the DEF tank 116 may maintain a gap 186b (best seen in FIG. 8) between the DEF tank 116 and the arm 144 of the first bracket 120. The gap 186b may be an air gap.

In one embodiment, the third flexible medium 122c may be a continuous foam panel without a hole therethrough. Similarly, in some embodiments the forth flexible medium 122d may be a continuous foam panel without a hole therethrough. In one embodiment, the third and fourth flexible mediums 122c, 122d are made of a foam that has a higher density than that of the first flexible medium 122a. For example, the third and fourth flexible mediums 122c, 122d may be closed cell expanded rubber foam such as cellular polychloroprene that requires in the range of about 15 kPA to about 35 kPA of pressure to compress the foam 25% of its thickness. The density may be in a range of about 140 kg/m³ to about 180 kg/m³.

The third flexible medium 122c may be of a different size and or shape than that of the fourth flexible medium 122d. In one embodiment, the third flexible medium 122c may have a smaller surface area than that of the fourth flexible medium 122d. The third flexible medium 122c may have a smaller outer perimeter 190 than the outer perimeter 192 of the fourth flexible medium 122d. In an embodiment, the third and fourth flexible mediums 122c, 122d may be configured to compress from expansion of the second sidewall 148b but not to the extent that the fuel tank 118 could contact and abrade the DEF tank 116.

The third portion 174 (FIG. 7) of the plurality of flexible mediums 122 may include a fifth flexible medium 122e. As best shown in FIGS. 3 and 11, the fifth flexible medium 122e may be disposed or sandwiched between the DEF tank 116 and the leg 164 of the angle bracket 124. The disposition of the fifth flexible medium 122e between the angle bracket 124 and the first sidewall 148a (for example, the upper portion 154 of the first sidewall 148a) of the DEF tank 116 may maintain a gap 186c (FIG. 3) between the DEF tank 116 and the ledge 146 of the first bracket 120. The gap 186c may be an air gap.

In the embodiment shown in FIG. 7, the fifth flexible medium 122e may be a continuous foam panel without a hole therethrough. In an embodiment, the fifth flexible medium 122e may be a foam that has a higher density than that of the first flexible medium 122a. For example, the fifth flexible 122e medium may be a closed cell expanded rubber foam such as cellular polychloroprene that requires about 15 kPA to about 35 kPA of pressure to compress the foam 25% of its thickness. In an embodiment, the density may be about 140 kg/m³ to about 180 kg/m³.

The fifth flexible medium 122e may be a different size and or shape than that of the other flexible mediums 122. In one embodiment, the fifth flexible medium 122e may have an outer perimeter 200 and surface area that is smaller than that of the first, second and/or fourth flexible mediums 122a, 122b, 122d. The fifth flexible medium 122e is configured to constrain the movement of the DEF tank 116 (in excess of expansion) in the fore-to-aft direction. However, the smaller surface area of the fifth flexible medium 122e (as compared to the other flexible mediums 122) allows the first DEF sidewall 148a to expand outward more than the other DEF sidewalls 148. Disposition of the fifth flexible medium 122e (and the angle bracket 124) at an angle as shown in FIG. 3 also constrains vertical movement of the DEF tank 116.

The fourth portion 176 (FIG. 9) of the plurality of flexible mediums 122 may include a sixth flexible medium 122f. As best seen in FIG. 3, the sixth flexible medium 122f may be disposed or sandwiched between the DEF top wall 150 and the hood striker member 126. The sixth flexible medium 122f is configured to constrain the movement of the DEF tank 116 (in excess of expansion) in the vertical direction. In one embodiment, the sixth flexible medium 122f (FIG. 9) may be a continuous foam panel without a hole therethrough. In an embodiment, the sixth flexible medium 122f may be a foam that has a higher density than that of the first flexible medium 122a. For example, in an embodiment, the sixth flexible medium 122f may be a closed cell expanded rubber foam such as cellular polychloroprene that may require about 15 kPA to about 35 kPA of pressure to compress the foam 25% of its thickness. The density may be about 140 kg/m³ to about 180 kg/m³.

The sixth flexible medium 122f may be a different size and or shape than that of the other flexible mediums 122. In one embodiment, the sixth flexible medium 122f may have an outer perimeter 202 that is smaller than that of the first flexible medium 122a.

The cooling assembly 128 may be disposed in the recess 130 proximal to the first sidewall 148a of the DEF tank 116. The cooling assembly 128 may be configured to provide cooling to the engine 110, hydraulics, operator compartment and the like on the machine 100/102. The cooling assembly 128 is configured to draw in air used for cooling. The air may be drawn in using a fan, or the like, as is known in the art. Because the DEF tank 116 is disposed next to the cooling assembly 128, air drawn into the cooling assembly 128 is also drawn across the DEF tank 116. Disposition of the DEF tank 116 in this air flow helps keep the temperature of the DEF contained in the DEF tank 116 under the recommended temperature limit for the DEF. The plurality of flexible mediums 122 may be configured to hold the DEF tank 116 away from the cooling assembly 128 so as not to inhibit air flow to the cooling assembly 128 but still expose the DEF tank 116 to the air flow drawn into the cooling assembly 128.

Also disclosed is a method of mounting a DEF tank 116 (FIG. 10) in a recess 130 of a frame 108 of a machine 100/102, the recess 130 containing a fuel tank 118. The method may comprise mounting a first bracket 120 (FIG. 6) to the frame 108, the first bracket 120 including a floor 142, and positioning the DEF tank 116 (FIG. 10) and a plurality of flexible mediums 122 in the recess 130 adjacent to the fuel tank 118 and the frame 108. Wherein the DEF tank 116 is disposed on top of the floor 142 (FIG. 6), a first portion 170 of the plurality of flexible mediums 122 is disposed between the DEF tank 116 (FIG. 10) and the frame 108, and a second portion 172 of the plurality of flexible mediums 122 is disposed between the DEF tank 116 and the fuel tank 118. Wherein further the plurality of flexible mediums 122 are configured to constrain the DEF tank 116 from movement that is in excess of expansion of the DEF tank 116. The method may further comprise adhering one or more of the flexible mediums 122 to the DEF tank 116 prior to insertion of the DEF tank 116 into the recess 130.

### INDUSTRIAL APPLICABILITY

When the machine 100/102 is operating, the DEF tank 116 may experience vibrations and other forces from the interaction of the machine 100/102 with loads and the ground surface. Such forces may exert side-to-side, fore-to-aft, vertical, vector and possibly torquing forces on the DEF tank 116. During operation of the machine 100/102, the plurality of flexible mediums 122 constrain movement of the DEF tank 116 in reaction to these forces. Furthermore, each of the plurality of flexible mediums 122 is configured to compress in response to expansion of the DEF tank 116 due to expansion of the DEF inside. Each of the flexible mediums 122 is also resilient and will uncompress/expand as the respective wall (of the DEF tank 116) pressing against it contracts (when the DEF inside the DEF tank 116 contracts) and will continue to fill the space between the DEF tank 116 and the frame 108, fuel tank 118, angle bracket 124 or hood striker member 126.

One or more of the flexible mediums 122 may be made of a low density foam. In addition, one or more of the flexible mediums 122 may be made of a higher density foam. Flexible mediums 122 made of higher density foam control the position of the DEF tank 116 and prevent contact of the DEF tank 116 with stiff or sharp portions of surrounding components or mounting hardware that could otherwise damage or weaken the DEF tank 116. A flexible medium 122 made of lower density foam facilitates expansion of the adjacent DEF sidewall 148 while still protecting the DEF sidewall 148 from damage from surrounding components due to forces (for example, side-to-side forces) acting on the DEF tank 116 during operation of the machine 100/102. In addition, during installation, such a lower density foam facilitates the ease of installation of the DEF tank 116 into the recess 130.

The features disclosed herein may be particularly beneficial for use with machines 100 that have DEF tanks 116 constrained from movement within the frame 108 recess 130. When the straps have been used to restrain DEF tanks 116, it can be very difficult to determine at installation the appropriate fit around the DEF tank 116 for the straps. If the straps are installed too tightly, they may wear or otherwise damage the DEF tank 116 when the DEF tank 116 expands. However, if installed too loosely, the straps may not constrain the DEF tank 116 as desired during operation of the machine 100. Thus, the ability to constrain the DEF tank 116 without the use of straps or the like and to maintain a more controlled positioning of the DEF tank 116 is beneficial and an advancement in this area.

What is claimed is:

1. A machine comprising:
a frame defining a recess configured to contain a DEF tank and a fuel tank;
a first bracket mounted to the frame;
the DEF tank disposed in the recess and on top of the first bracket, wherein the DEF tank is expandable;
the fuel tank disposed inside the recess; and
a plurality of flexible mediums, a first portion of the plurality of flexible mediums sandwiched between the DEF tank and the frame, and a second portion of the plurality of flexible mediums sandwiched between the DEF tank and the fuel tank, each of the plurality of flexible mediums configured to constrain the DEF tank from movement that is in excess of expansion of the DEF tank.

2. The machine of claim 1, wherein each of the plurality of flexible mediums is made of foam.

3. The machine of claim 2, wherein at least one of the plurality of flexible mediums has a lower density than an other flexible medium of the plurality.

4. The machine of claim 1, wherein at least one of the plurality of flexible mediums has a general ring shape that defines a hole therethrough.

5. The machine of claim 1, further comprising an angle bracket mounted to the frame and disposed adjacent to the DEF tank, wherein a third portion of the plurality of flexible mediums is sandwiched between the angle bracket and the DEF tank.

6. The machine of claim 5, wherein the angle bracket is mounted the frame at an angle to a horizontal plane.

7. The machine of claim 5, in which a forth portion of the plurality of flexible mediums is disposed on top of the DEF tank.

8. A method of mounting a DEF tank in a recess of a frame of machine, the recess containing a fuel tank, the method comprising:
mounting a first bracket to the frame, the first bracket including a floor; and
positioning the DEF tank and a plurality of flexible mediums in the recess adjacent to the fuel tank and the frame,
wherein the DEF tank is disposed on top of the floor, a first portion of the plurality of flexible mediums is disposed between the DEF tank and the frame, and a second portion of the plurality of flexible mediums is disposed between the DEF tank and the fuel tank, wherein further the plurality of flexible mediums are configured to constrain the DEF tank from movement that is in excess of expansion of the DEF tank.

9. The method of claim 8, wherein each of the plurality of flexible mediums is a foam panel.

10. The method of claim 9, wherein, at least one of the plurality of flexible mediums has a lower density than an other flexible medium of the plurality.

11. The method of claim 9, further comprising adhering one or more of the plurality of flexible mediums to the DEF tank.

12. A machine comprising:
a frame defining a recess configured to contain a DEF tank and a fuel tank, the frame including a frame wall disposed on a side of the machine and intersecting a frame endwall disposed at a rear of the machine;
a first bracket mounted to the frame wall and to the frame endwall, the first bracket oriented substantially horizontally;
the DEF tank disposed in the recess and on top of the first bracket, wherein the DEF tank is expandable and includes a plurality of sidewalls;
an angle bracket mounted to the frame wall and disposed substantially parallel to a portion of a first sidewall of the DEF tank, the first sidewall disposed opposite to the frame endwall;
the fuel tank disposed inside the recess, a first part of the fuel tank disposed proximal to a second sidewall of the DEF tank, the second sidewall disposed opposite to frame wall; and
a plurality of flexible mediums, the plurality including a first portion of the plurality sandwiched between the DEF tank and the frame, and a second portion of the plurality sandwiched between the DEF tank and the fuel tank, and a third portion of the plurality sandwiched between the angle bracket and the DEF tank, the plurality of flexible mediums configured to constrain the DEF tank from movement within the recess that is in excess of expansion of the DEF tank, wherein each of the plurality of flexible mediums is made of foam.

13. The machine of claim 12, wherein, the angle bracket is mounted at an acute angle to a horizontal plane.

14. The machine of claim 12, further comprising a hood striker member disposed adjacent to the frame wall and above the DEF tank.

15. The machine of claim 14, in which the plurality of flexible mediums further includes a fourth portion sandwiched between a top wall of the DEF tank and the hood striker member.

16. The machine of claim 12, wherein the first sidewall of the DEF tank includes an upper portion and a lower portion, the upper and lower portions angled toward each other and meeting at a vertex.

17. The machine of claim 12, wherein at least one of the plurality of flexible mediums is made of high density closed cell expanded rubber.

18. The machine of claim 12, wherein at least one of the plurality of flexible mediums is made of an open cell foam.

19. The machine of claim 12, wherein at least one of the flexible mediums of the second portion is a continuous foam panel without a hole therethrough.

20. The machine of claim 12, wherein the wherein the machine is a vibratory compactor.
